(19) United States
(12) Patent Application Publication
(10) Pub. No.: US 2004/0257423 A1
(43) Pub. Date: Dec. 23, 2004

(54) Color reproducing apparatus and method

(76) Inventor: Ken Ota, Cupertino, CA (US)

Correspondence Address: James A. LaBarre, BURNS, DOANE, SWECKER & MATHIS, L.L.P., P.O. Box 1404, Alexandria, VA, 22313-1404, US

(21) Appl. No.: 10/600,592

(22) Filed: Jun. 23, 2003

(51) Int. Cl. G06K 15/14; B41J 2/435

(52) U.S. Cl. 347/115; 347/132

(57) ABSTRACT

In a color reproducing system an image to be reproduced is analyzed to identify which color toner cartridges are required to print the image. Based on the identification, the color reproducing system selectively enables only those toner cartridges which are required to reproduce the image. In a host-based system the identification can be performed by a computer which provides the identification to a reproducing apparatus. In a controller-based system the identification is performed by a controller in the reproducing apparatus.

### BACKGROUND OF THE INVENTION

The present invention is directed to methods and apparatus for a color reproduction apparatus, and more specifically to the reduction of wear on parts in color reproducing apparatus.

Currently there are many types of color laser reproduction apparatus. For example, color laser reproduction can be employed in printers, facsimile machines, and photocopying machines. Color reproduction apparatus generally employ the colors of cyan (C), magenta (M), yellow (Y) and black (K). Typically, a separate toner cartridge is utilized for each of the four colors employed in the reproduction process.

The operation of a color reproduction apparatus is well known. Specifically, the reproduction apparatus employ a photosensitive drum which is charged by a corona charger. Light is incident on the photosensitive drum to discharge those areas of the drum which correspond to portions of the image which are not to be reproduced, i.e., the portions which do not require toner. For instance, in a laser reproduction apparatus, the incident light can be a modulated laser beam that scans the drum. The sleeve of a toner cartridge contacts the photosensitive drum, and the toner is attracted to those portions of the photosensitive drum which still contain an electrical charge. A sheet of paper is applied to the photosensitive drum to transfer the toner onto the paper. Finally, a fixing mechanism, such as heated fixing rollers, affixes the toner to the paper to thereby produce a printed image.

Generally, color reproduction apparatus can be categorized either as a tandem-type reproduction apparatus or a four-cycle reproduction apparatus, depending upon the manner in which the color is applied to the paper. FIG. 1A illustrates a conventional tandem-type color reproduction apparatus. Tandem-type color reproduction apparatus are characterized by the use of a separate photosensitive drum, corona charger, transfer charger, and light source for each toner cartridge. Accordingly, as illustrated in FIG. 1A, photosensitive drum 2Y, transfer charger 4Y, light source 5Y, and corona charger 6Y are associated with the yellow toner cartridge 3Y; photosensitive drum 2M, transfer charger 4M, light source 5M, and corona charger 6M are associated with the magenta toner cartridge 3M; photosensitive drum 2C, transfer charger 4C, light source 5C, and corona charger 6C are associated with the cyan color cartridge 3C; and photosensitive drum 2K, transfer charger 4K, light source 5K, and corona charger 6K are associated with the black toner cartridge 3K. In operation a sheet of paper 11 is placed on belt 10 in order to pass the sheet of paper 11 across the photosensitive drums 2Y, 2M, 2C and 2K. The photosensitive drums 2 are charged by corona chargers 6 and contact a corresponding rotatable sleeve 9 for application of the toner to the paper 11. Transfer chargers 4 apply a charge to the paper 11 to attract the toner to the paper. Each of the photosensitive drums applies toner to the paper in accordance with those portions of the drum which have not been discharged by the light source. After passing photosensitive drum 2K, the sheet of paper 11 is passed through fixing rollers 7 which apply heat to affix the applied toner to the sheet of paper 11.

FIG. 1B illustrates a conventional four-cycle color reproduction apparatus. The four-cycle color reproduction apparatus employs a developing rack 90 which comprises the cyan color toner cartridge 30C, the magenta color toner cartridge 30M, the yellow color toner cartridge 30Y, and the black color toner cartridge 30K. As illustrated in FIG. 1B, a four-cycle color reproduction apparatus is characterized by the use of a single corona charger 50, a single transfer charger 65, a single photosensitive drum 60, and a single light source 70, for applying all four toner colors. In operation, a belt 80 is employed to pass a sheet of paper 11 by the photosensitive drum 60 for application of the toners. Specifically, the piece of paper 11 makes four passes across photosensitive drum 60, for each pass the developing rack 90 is rotated such that an associated rotatable sleeve 40 contacts photosensitive drum 60. After the four passes by the sheet of paper 11, the sheet of paper 11 passes by fixing rollers (not illustrated) for affixing the toner to the piece of paper 11.

In conventional color reproduction apparatus each color toner cartridge is applied to a photosensitive drum, which contacts a sheet of paper, regardless of whether the color is necessary to reproduce the image on the sheet of paper 11. This results in unnecessary operation of the photosensitive drum, transfer chargers, corona chargers, light sources and developing rollers. The unnecessary usage of the toner cartridges can result in excess wear of the developing rollers, scrapers, bearings and other mechanical parts, thereby requiring replacement of the toner cartridge when the toner cartridge still contains toner. Moreover, this unnecessary use of the photosensitive drum, transfer chargers, corona chargers, light source and belt can reduce the life of the color reproduction apparatus.

### SUMMARY OF THE INVENTION

To reduce wear of toner cartridges and of components of a color reproducing apparatus, an identification of the colors required to reproduce an image is performed. Based upon the identification, a color reproducing apparatus enables only those color imaging elements which are required to reproduce the image. In a host-based system, a computer performs the identification. In a controller-based system, a controller in the color reproducing apparatus performs the identification. The identification can be performed on a page-by-page basis.

The present invention is applicable to both tandem-type and 4-cycle color reproducing apparatus. Moreover, the color reproducing apparatus can be a printer, a photocopying machine, or a facsimile machine.

### BRIEF DESCRIPTION OF THE DRAWING FIGURES

The objects and advantages of the invention will be understood by reading the following detailed description in conjunction with the drawings, in which:

FIG. 1A illustrates a conventional tandem-type color reproduction apparatus.

FIG. 1B illustrates a conventional four-cycle color reproduction apparatus.

FIG. 2 illustrates an exemplary method employed in accordance with the present invention.

FIG. 3A illustrates a computer and a host-based printer.

FIG. 3B illustrates a computer and a controller-based printer.

FIG. 4 illustrates a mechanism for enabling a toner cartridge in accordance with exemplary embodiments of the present invention.

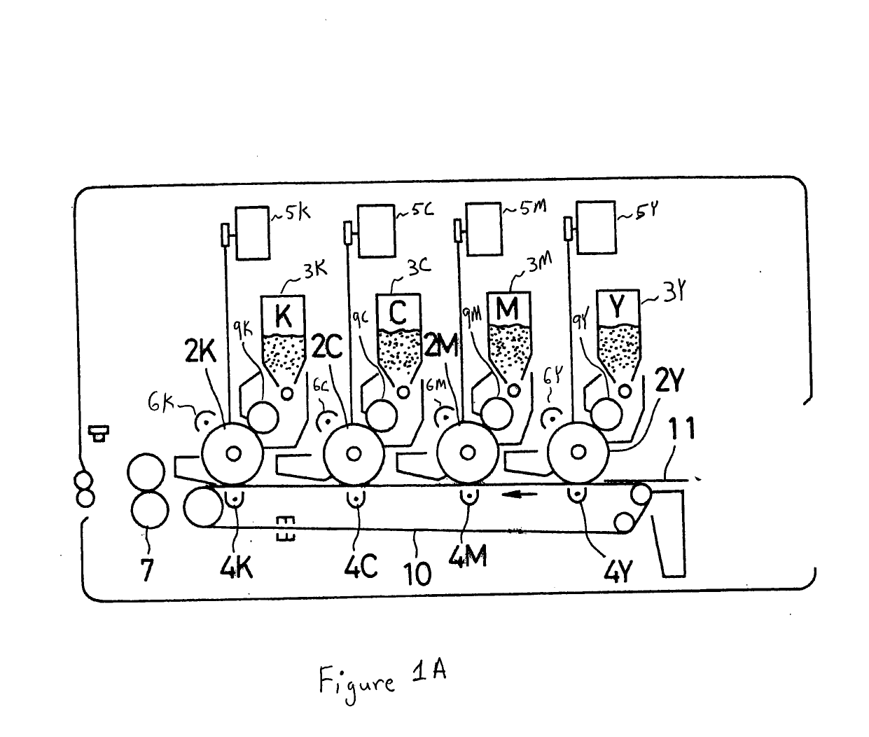

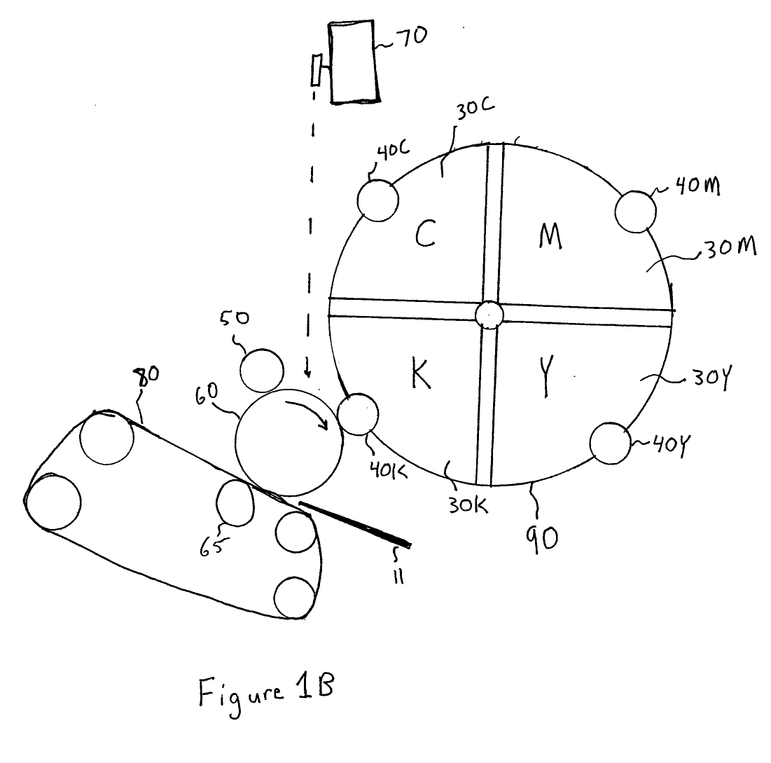

### DETAILED DESCRIPTION OF THE INVENTION

The various features of the invention will now be described with reference to the figures, in which like parts are identified with the same reference characters.

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well known methods, devices, and circuits are omitted so as not to obscure the description of the present invention.

Exemplary embodiments of the present invention reduce wear on the color laser reproduction apparatus by enabling only those toner cartridges which contain colors present in the image to be printed. It should be recognized that if the toner cartridges are considered to be in an enabled state prior to printing, then only those toner cartridges for which the associated color is not required to reproduce the image are disabled.

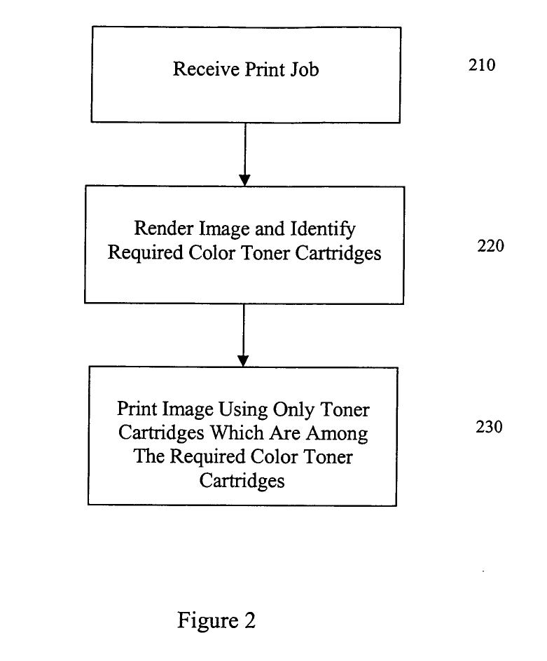

FIG. 2 illustrates an exemplary method in accordance with the present invention. Initially, a print job is received (step 210). Next the image is rendered and the color toner cartridges required to print the image are identified (step 220). It will be recognized that a color which is to be reproduced may require a combination of two or more toner colors. Accordingly, it may occur that even if the toner color itself is not present in the image, the toner color may be required to reproduce the image. Finally, the image is printed by employing only those toner cartridges which are among the required color toner cartridges (step 230). If the identification of required color toner cartridges is performed on a page-by-page basis, then the method of FIG. 2 will perform steps 210-230 for each page.

Where the particular steps of the method of FIG. 2 occur depend upon the type of color reproduction apparatus employed. Color reproduction apparatus can generally be categorized as either host-based or controller-based.

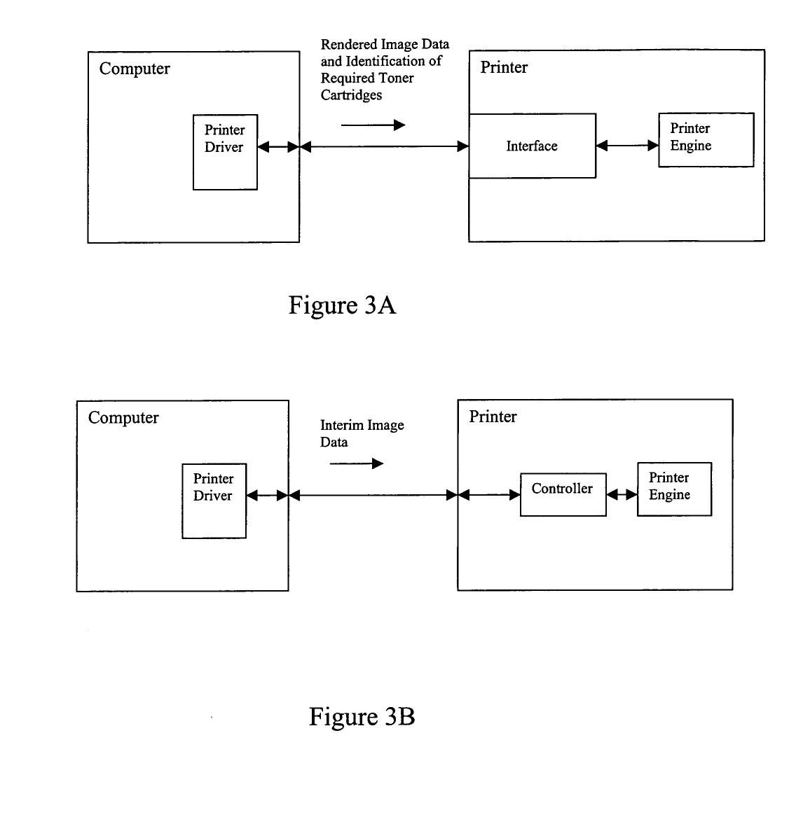

FIG. 3A illustrates the arrangement in a host-based color reproduction system. The system includes a computer 310 and a printer 330A. The computer 310 includes a print driver 320A which renders the image. The rendered image is provided to the printer 330A via printer interface 340. The printer interface 340 provides the rendered image to print engine 350. In accordance with exemplary embodiments of the present invention, in a host-based system, the print driver 320A provides the rendered image, along with an identification of the colors which are to be used to print the image. The identification of the colors to be employed in printing the image can be provided by the printer driver 320A in the print job header. The printer 330A interprets the print job header and enables the toner cartridges that are associated with any of the identified colors in the image. Host-based printers are generally known as GDI or Raster printers.

FIG. 3B illustrates a controller-based color reproduction system in accordance with exemplary embodiments of the present invention. Specifically, the system includes a computer 310 and a printer 330A. The computer 310 includes a printer driver 320B which provides interim image data to the printer 330B. The interim image data is received by a controller 345 which renders the image and identifies the color toner cartridges required to print the image. The rendered image, as well as an identification of the toner cartridges required to print the image, are provided to print engine 350 which selectively enables the toner cartridges that are associated with any of the identified colors in the image. Controller-based printers are generally known as Page Description Language (PDL) printers, e.g., Postscript printers and Printer Control Language (PCL) printers.

It will be recognized that a tandem-type printer or a four-cycle type printer can be either host-based or controller-based. Additionally, if the present invention is implemented in a facsimile machine or in a photocopying machine, then the operation occurs similar to that described above in connection with FIG. 3B. Specifically, in a photocopying machine or in a facsimile machine there would be no computer 310. Instead, the controller 345 would receive the interim image data either from a scanning mechanism (for a facsimile machine or for a photocopying machine), or from a communication line (for a facsimile machine). Additionally, if the photocopying machine or the facsimile machine is connected to a computer network, the controller would receive interim raw image data from a network interface.

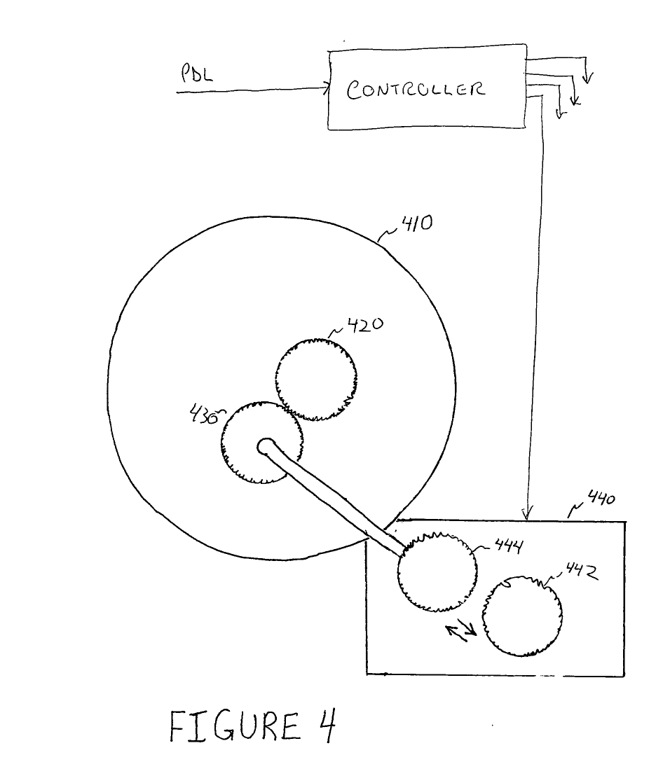

FIG. 4 illustrates a mechanism for enabling a toner cartridge in accordance with exemplary embodiments of the present invention. The rotatable sleeve 410 of each toner cartridge includes a gear 420. The printer engine (not illustrated) controls a clutch 440. The clutch selectively engages clutch gears 442 and 444 depending upon whether the particular toner cartridge is enabled for printing a particular image. When the clutch 440 is engaged, gear 430 interacts with gear 420 to cause the rotatable sleeve 410 to rotate, and thereby apply toner to a photosensitive drum. Moreover, with regard to a four-cycle type reproduction apparatus, the developing rack can be rotated past a toner cartridge which is not employed to print a particular image to the next toner cartridge required to print the particular image. This has the advantage of reducing wear on the belt.

Although the present invention has been described in connection with particular types of color reproduction apparatus, it should be recognized that the present invention is equally applicable to any type of color reproduction apparatus which employs separate mechanisms for applying different colors. For example, the present invention is equally applicable to laser-based color reproduction apparatus, as well as color reproduction apparatus which employ other types of light. In these embodiments, the mechanisms for colors which are not used to print the image are disabled in a similar manner to that described above.

The invention has been described herein with reference to particular embodiments. However, it will be readily apparent to those skilled in the art that it may be possible to embody the invention in specific forms other than those described above. This may be done without departing from the spirit of the invention. Embodiments described above are merely illustrative and should not be considered restrictive in any way. The scope of the invention is given by the appended claims, rather than the preceding description, and all variations and equivalents which fall within the range of the claims are intended to be embraced therein.

What is claimed is:

1. A color reproduction system, comprising:
a plurality of selectively activatable imaging components, each of which is associated with a different respective color;
means for identifying colors in an image to be reproduced; and
a controller which disables selected ones of said imaging components that are not associated with any of the identified colors in the image.

2. The color reproduction system of claim 1, wherein said imaging components are movable elements of a toner cartridge.

3. The color reproduction system of claim 2, wherein said movable elements comprise rotatable sleeves.

4. The color reproduction system of claim 2, wherein said imaging components further comprise a laser associated with each of the toner cartridges.

5. The color reproduction system of claim 1, wherein said imaging components comprise photoconductive drums.

6. The color reproduction system of claim 1, wherein said identifying means comprises a printer driver.

7. The color reproduction system of claim 1, wherein said identifying means comprises a printer engine that is responsive to data in a page description language.

8. The color reproduction system of claim 1, further comprising:
a clutch, wherein the controller selectively disables the clutch based on the disabled imaging components.

9. The color reproduction system of claim 1, wherein the color reproduction system is a color laser printer.

10. The color reproduction system of claim 1, wherein the color reproduction system is a facsimile machine.

11. The color reproduction system of claim 1, wherein the color reproduction system is a photocopying machine.

12. A method for reproducing a color image, comprising the following steps:
identifying colors in an image to be printed; and
activating selected ones of a plurality of imaging components that are respectively associated with the identified colors in the image to be printed.

13. The method of claim 12, wherein said imaging components are movable elements of a toner cartridge.

14. The method of claim 13, wherein said movable elements comprise rotatable sleeves.

15. The method of claim 13, wherein said imaging components further comprise a laser associated with each of the toner cartridges.

16. The method of claim 12, wherein said imaging components comprise photoconductive drums.

17. The method of claim 12, wherein said identifying and activating steps are performed on a page-by-page basis for the document to be printed.

18. The method of claim 12, wherein the image is printed by a printer.

19. The method of claim 12, wherein the image is printed by a facsimile machine.

20. The method of claim 12, wherein the image is printed by a photocopying machine.
